(19) United States
(12) Patent Application Publication
(10) Pub. No.: US 2011/0161169 A1
(43) Pub. Date: Jun. 30, 2011

(54) Advertisement selection for a product or service to display to user

(76) Inventors: Sandeep Ramesh, Pune (IN); Dwip N. Banerjee, (US); Sachin C. Punadikar, Pune (IN); Vipin Rathor, Pune (IN)

(21) Appl. No.: 12/647,322

(22) Filed: Dec. 24, 2009

(51) Int. Cl. G06Q 30/00; H04N 7/10

(52) U.S. Cl. 705/14.53; 705/14.66; 725/32

(57) ABSTRACT

One or more attributes of a user are determined. A given advertisement for an product or service, such as a product or a service, is selected from a number of advertisements for the product or service, based on the attributes of the user. The given advertisement for the product or service that is selected is then electronically displayed, for viewing by the user.

### BACKGROUND

Advertisements are frequently displayed to users. Such advertisements are said herein to be for entities, where an entity may be a product or a service, for instance, which is advertised to users so that the users will purchase, rent, use, or otherwise be exposed to the entity. An advertisement may be displayed during a commercial break of a television program that a user is currently viewing. An advertisement may also be displayed on a web page of an Internet web site that a user is currently viewing.

Problematically, it is becoming more difficult to interest users in actually viewing advertisements. Digital video recorders (DVR's) permit users to pre-record television programs for viewing at a later time, such that the users are able to skip past the commercial breaks. Furthermore, users frequently ignore advertisements that are displayed on web pages of Internet web sites that the users are browsing. As such, advertisers are having more difficulty ensuring users view their advertisements.

### SUMMARY

Embodiments of the present invention relate to selecting which advertisement for an entity to display to a user. A method of an embodiment of the invention determines one or more attributes of a user, such as a given type of theme of multimedia content that most appeals to the user. A processor of a computing device selects a given advertisement for an entity from a number of advertisements for the entity, based on the attributes of the user. Thus, there are numerous different advertisements for the entity, and one is selected based on the attributes of the user, such as based on the given type of theme of multimedia content that most appeals to the user. The given advertisement selected is then electronically displayed for viewing by the user.

A system of an embodiment of the invention includes one or more processors, a first database, a second database, and a computer-readable medium. The first database stores a list of multimedia content previously viewed by a user. Each multimedia content has one or more associated themes. The second database stores a number of different advertisements for the same entity. Each advertisement is particular to a different theme. The computer-readable medium stores first and second computer program code. The first code determines the most popular theme of the multimedia content previously viewed by the user, from the associated themes of the multimedia content previously viewed by the user. The second code is to select a given advertisement from the advertisements for the entity, to display to the user. The given advertisement is selected as the advertisement that has a theme which best matches the most popular theme of the multimedia content previously viewed by the user.

A computer program product of an embodiment of the invention has one or more computer programs stored thereon. Execution of the computer programs from the computer program product by one or more processors causes a method to be performed. The method determines or more attributes of a user, and selects a given advertisement for an entity from a number of different advertisements for the entity, based on the attributes of the user. As such, the given advertisement selected best matches the attributes of the user as compared to all other advertisements for the entity.

Still other embodiments of the invention will become apparent by reading the detailed description that follows, and by referring to the accompanying drawings.

### BRIEF DESCRIPTION OF THE DRAWINGS

The drawings referenced herein form a part of the specification. Features shown in the drawing are meant as illustrative of only some embodiments of the invention, and not of all embodiments of the invention, unless otherwise explicitly indicated, and implications to the contrary are otherwise not to be made.

FIG. 1 is a diagram of a system, according to an embodiment of the invention.

FIG. 2 is a flowchart of a method, according to an embodiment of the invention.

FIG. 3 is a diagram of a representative computing device, according to an embodiment of the invention.

### DETAILED DESCRIPTION OF THE DRAWINGS

In the following detailed description of embodiments of the invention, reference is made to the accompanying drawings that form a part hereof, and in which is shown by way of illustration specific embodiments in which the invention may be practiced.

These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the present invention is defined only by the appended claims.

Embodiments of the present invention assist advertisers in ensuring that users view their advertisements. For example, there may be a number of different advertisements for a given entity, such as a given product or service. Each advertisement may be particular to a different theme for the same entity. For instance, one advertisement may be comedy-related, another advertisement may be drama-related, and a third advertisement may be realty-related, although all the advertisements are nevertheless for the same product. The attributes of the user determine which of these different advertisements is most likely to appeal to the user, and it is this selected advertisement that is ultimately displayed to the user.

In this sense, a profile of a user—such as a history of the types of multimedia content that the user has viewed (e.g., comedies, dramas, reality television shows, and so on)—is used to determine which particular advertisement for a given entity is to be displayed to the user. Note that this is different than determining which entity for which an advertisement is to be displayed to the user. In the latter scenario, there may be an advertisement for a car, an advertisement for toothpaste, and an advertisement for a movie, and the profile of the user is employed to select which of these advertisements—for different products—is displayed to the user.

By comparison, in embodiments of the invention, there may be a comedy-related advertisement for a car, a drama-related advertisement for the same car, and a reality-related advertisement for this car. Thus, in embodiments of the invention, the profile of the user is employed to select which of these advertisements—for the same product—is displayed to the user. That is, once it has been decided that an advertisement for a given product or service is to be displayed to the user, embodiments of the invention are employed to determine which of a number of different advertisements for this product or service is actually displayed to the user.

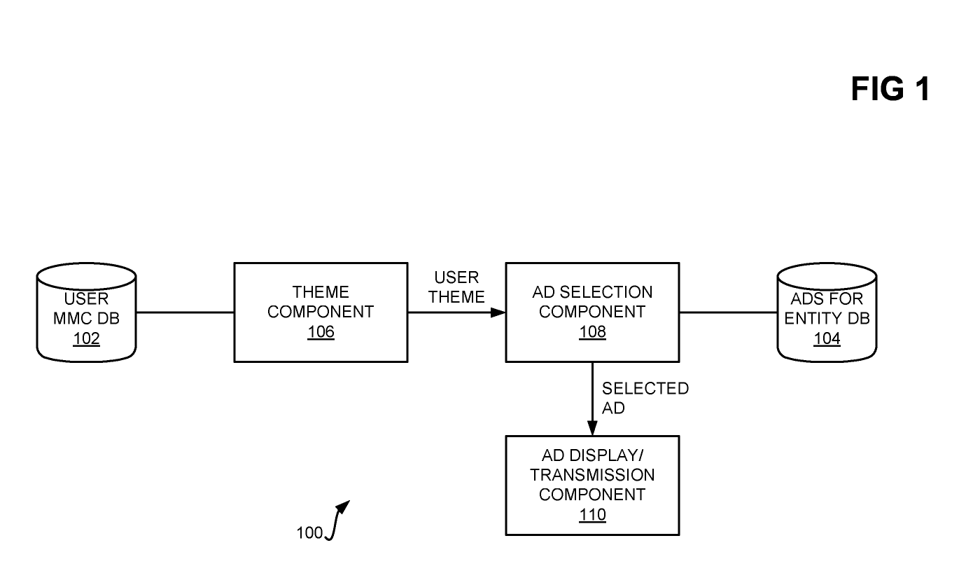

FIG. 1 shows a system 100, according to an embodiment of the invention. Operation of an embodiment of the invention is described in relation to the system 100. The system 100 includes two databases 102 and 104, and three components 106, 108, and 110. The components 106, 108, and 110 may each be implemented in hardware, or a combination of software and hardware. For instance, each component may be implemented as one or more computer programs stored on a computer-readable medium, from which the programs are executed by one or more processors of one or more computing devices to realize the respective functionality of the component.

The theme component 106 interacts with the user multimedia content database 102. The multimedia content database 102 stores a profile of the user, specifically a list of multimedia content that the user has previously viewed. For example, the database 102 may store a list of movies and television shows that the user has previously viewed. Each multimedia content has one or more associated themes. For example, such themes can include comedy, drama, emotion, action, and reality-based. Such themes can of course include other types of themes, beyond those listed here. One multimedia content may be associated with comedy and action, for instance, whereas another content may be associated with just being reality-based.

The theme component 106 determines the most popular theme of the multimedia content previously viewed by the user, from the themes associated with this multimedia content stored in the database 102. The most popular theme is the theme that appears most frequently among the multimedia content. This can be achieved by tallying a count of multimedia content for each theme. For example, comedy may be associated with 25 multimedia content, action may be associated with 10 multimedia content, and the other themes may each be associated with less than 10 multimedia content. Thus, comedy is the most popular theme of the multimedia content previously viewed by the user.

This most popular user theme is transmitted from the user theme to the advertisement selection component 108. The advertisement selection component 108 interacts with the entity advertisements database 104. The entity advertisements database 104 stores a number of different advertisements for the same entity, such as for the same product or service, or other entity. Each advertisement is particular to a different theme. For example, one advertisement for the entity may be a comedy advertisement, another advertisement for the entity may be a drama advertisement, and so on.

The advertisement selection component 108 selects an advertisement for the entity from the advertisements for the entity stored within the database 104. In particular, the advertisement selection component 108 selects the advertisement that has a theme which best matches the most popular theme of the multimedia content previously viewed by the user, as determined by the theme component 106. For example, if the most popular theme of the multimedia content previously viewed by the user is comedy, then the advertisement for the entity that has a comedy theme is selected.

The selected advertisement is transmitted from the advertisement selection component 108 to the advertisement display/transmission component 110. The component 110 either electronically displays the selected advertisement for viewing by the user, or transmits the selected advertisement to a different system for electronic display for viewing by the user. For example, the component 110 may electronically display the selected advertisement on a web page of an Internet web site currently being browsed by the user. As another example, the component 110 may transmit the selected advertisement to a cable television company to electronically display to the user within a commercial break of a television program that the user is currently viewing or recording.

It is noted that within the system 100, it has been a priori decided that an advertisement for a given entity—e.g., a given product or service—is to be displayed to the user. What the system 100 selects is which advertisement for the entity to display to the user, where there are a number of different types of advertisements for the entity, corresponding to the different themes that have been described. The system 100 thus does not select an advertisement to display to the user among a number of advertisements for different entities—e.g., different products or services.

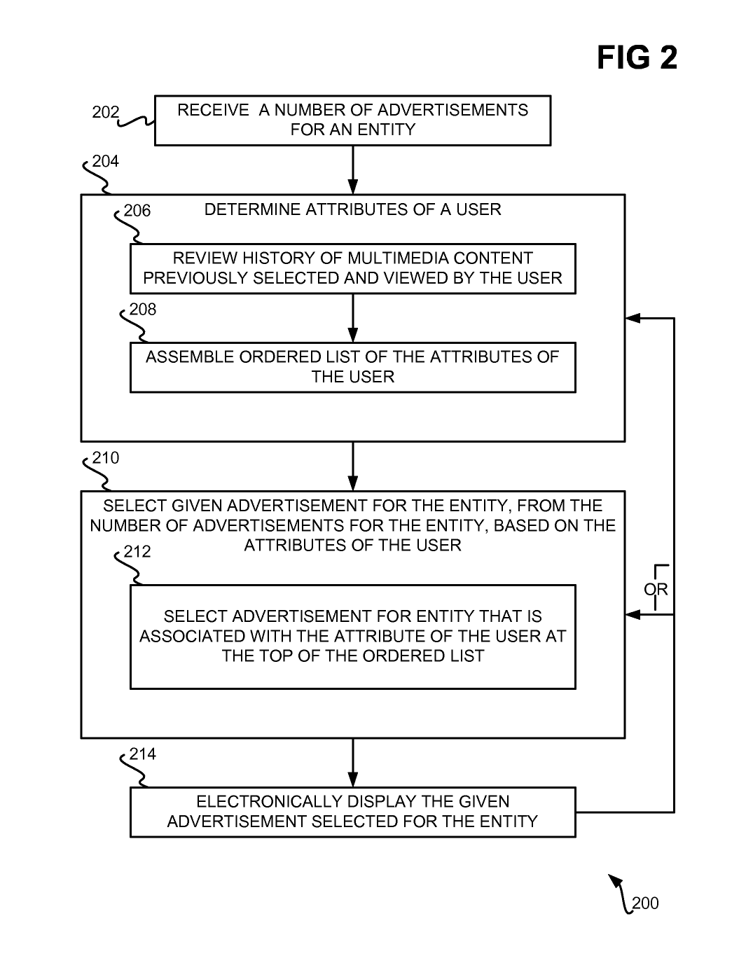

FIG. 2 shows a method 200, according to an embodiment of the disclosure. At least some parts of the method 200 may be performed by a processor of a computing device. For example, a processor may execute computer program code from a computer-readable medium to perform these parts. The computer-readable medium may be a volatile medium, such as volatile semiconductor memory, or a non-volatile medium, such as a hard disk drive or non-volatile semiconductor memory, among other types of computer-readable media.

A number of advertisements for a given entity, such as a product or a service to be advertised, are received (202). The advertisements for the entity are different from one another. For example, the advertisements may be intended to appeal to different types of audiences, by, for instance, having different themes, as has been described above.

One or more attributes of a user are determined (204). The user is to have an advertisement for the entity in question displayed to him or her. The attributes of the user indicate the likes, dislikes, and/or interests of the user, particularly as related to what types of advertisements the user may be interested in viewing for the entity (as opposed to what types of entities for which user may be interested in viewing advertisements). The types of attributes of the user that can be determined, or how such attributes of the user are determined, is not limited by embodiments of the present invention.

However, in one specific embodiment, a history of multimedia content that has been previously selected and viewed by the user is reviewed (206). For example, a cable television company may track the advertisements that the user purposefully viewed and did not skip over when using a digital video recorder (DVR). As another example, the history of multimedia content may include video clips that the user has selected and viewed on video-sharing web sites. Other examples of multimedia content include television shows, movies, and other types of video programs viewed by the user, web pages of Internet web sites viewed by the user, and so on. The manner by which the multimedia content history is tabulated is thus not limited by embodiments of the present invention.

Each multimedia content has one or more associated attributes that can be attributed to the user. As such, an ordered list of attributes of the user is assembled based on these associated attributes of the multimedia content within the user's history (208). For example, each multimedia content may have one or more attributes, where a given attribute may be associated with more than one multimedia content. Therefore, for each unique attribute, the number of times the attribute is associated with multimedia content within the user's history is counted, and the attributes are sorted by this count.

The user's attributes may be at least substantially static, or they may be at least substantially dynamic. Where the attributes are at least substantially static, this means that the user's attributes do not change frequently, such that the attributes of the user just have to be determined in part 204 on an infrequent basis, and not each time an advertisement is selected for displaying to the user. By comparison, where the attributes are at least substantially dynamic, this means that the user's attributes may change frequently, such that the attributes of the user have to be determined in part 206 on a frequent basis, such as each time an advertisement is selected for displaying to the user.

Another example of how a user's attributes are determined is for the user to explicitly state his or her preferences, or select them for a list. For example, the user may be provided with a list of themes, such as comedy, reality, action, and so on. The user may then be permitted to select the themes that he or she is interested in, or may be permitted to rank the themes in the order of interest. Such preference selection may be achieved online, via the user using a computing device communicatively connected to the Internet, for instance. Such preference selection can also be achieved through a bidirectional cable television connection, where the user enters or selects the preferences as display on a television or other display, through a cable box connected to the provider of the cable television service.

Still other ways as to how a user's attributes can be determined are also encompassed by embodiments of the invention. For instance, online surveys or other types of surveys may be performed to elicit the user's attributes from the user. The user's attributes may also be retrieved from the user's past history of video rentals and/or downloads. For example, if a user uses a given video rental and/or download service, the history of the user's rental and/or downloads of these videos may be employed to determine the user's attributes.

A given advertisement for the entity is selected from the number of advertisements for the entity, based on the attributes of the user that have been determined (210). More specifically, the advertisement that best matches the attributes of the user is selected. In one embodiment, the given advertisement for the entity is selected as the advertisement that is associated with the user's attribute at the top of the ordered list that has been determined (212). If no advertisement matches the attribute at the top of the ordered list, the advertisement matching the next attribute within the list is selected, and so on. Other sophisticated methodologies for selecting an advertisement are also within the scope of embodiments of the invention. For example, the ordered list may be considered as providing weights of the various attributes, and an advertisement is selected as having the most similar weighting of the attributes.

The selected advertisement for the entity is then electronically displayed to the user (214). As has been noted above, the selected advertisement may be displayed on a television channel on which the user is currently watching a television program, during a commercial break. As another non-limiting example, the selected advertisement may be displayed on a web page of an Internet web page that the user is currently browsing. The selected advertisement may be a video having both moving pictures and sound, an audio-only advertisement, or a static non-moving image.

Embodiments of the invention include displaying the selected advertisement for the entity in other ways as well, and are not limited to advertisements being displayed during a commercial break in a television program, or on a web page of an Internet web site. For example, a selected advertisement can be displayed on an electronic billboard within an airport or other real-world setting. So long as the electronic billboard is able to identify the user (e.g., via radio frequency identification, or RFID, technology, mobile phone Bluetooth technology, a user's electronic airplane ticket, and so on), and the user's attributes have been or can be determined, an appropriate advertisement for a given product can be displayed to the user. As another example, a selected advertisement can be displayed within a virtual world or environment, such as within a virtual three-dimensional world in which users virtually interact with one another electronically, such as over the Internet.

As a final example, libraries of videos from which a user rents or downloads a given video may be able to dynamically insert appropriate advertisements for the user before, after, or during display of the video. For example, a documentary film may be sponsored by the manufacturer of a given product. When a user rents the documentary film, an appropriate advertisement for the product (or for the manufacturer itself) may be inserted before, after, or during display of the video to the user. Depending on the user's attributes, this advertisement is different, although the advertisement is always for the product (or for the manufacturer) in question, regardless of the user's attributes. That is, as has been described above, it is the type of advertisement that is varied, not which product or service that is being advertised, the latter which is predetermined.

The method 200 can be repeated from part 214 to either part 204 or part 210 to select an advertisement for a different entity for display to the user. The method 200 proceeds to part 204 where the attributes of the user are dynamic and/or otherwise need to be immediately redetermined. By comparison, the method 200 proceeds to part 210 where the attributes of the user are static and/or otherwise do not need to be immediately redetermined. In either case, the method 200 selects an advertisement for a new entity for display to the user.

The method 200 thus presumes that it has been decided a priori to display an advertisement for a given entity to the user. What the method 200 determines is which advertisement of a number of advertisements for the same entity—e.g., the same product and/or the same service—is to be displayed to the user. As has been described above, this differs from advertisement selection methodologies in which there are a number of different advertisements for a correspondingly number of different entities. The method 200 is not selecting among different types of advertisements for different entities—that is, the method 200 is not selecting in any way the entity for which an advertisement is to be displayed to the user. Rather, it is known that an advertisement for a preselected entity is to be displayed to the user, and the method 200 is selecting which advertisement for this preselected entity is to be displayed to the user.

As an example of how one given embodiment of the invention is advantageous, the following scenario is considered. A live sporting program, or another type of television program either live or recorded, is broadcast to many users simultaneously, as is typical. During a commercial break in the program, a given product is advertised. However, the advertisements that particular users actually see for the product are varied. For example, a first user more interested in drama may see a drama-oriented advertisement for the product, while at the same time a second user more interest in comedy may see a comedy-oriented advertisement for the product. As such, during a particular commercial slot, the same product is advertised to both users. However, the first user sees a different advertisement for the product than the second user sees. As such, the potential for the product being successfully advertised is greater.

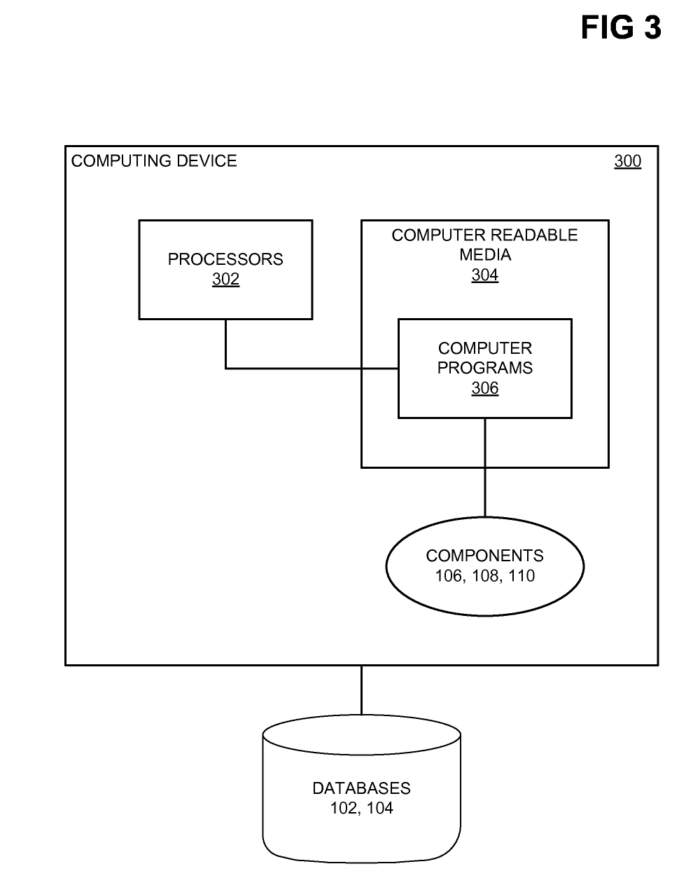

FIG. 3 shows a representative computing device 300, according to an embodiment of the invention. The computing device 300 includes one or more processors 302 and one or more computer-readable media 304. The computing device 300 typically includes other hardware as well, in addition to the processors 302 and the computer-readable media 304, such as network adapters, input devices, output devices, and so on. The computer-readable media 304 can include volatile media, such as volatile semiconductor memory, as well as non-volatile media, such as non-volatile semiconductor memory and/or hard disk drives.

The computer-readable media 304 store one or more computer programs 306. The computer programs 306 contain computer program code. The computer programs 306 are executed by the processors 302 executing the computer program code of the computer programs 306. The components 106, 108, and 110 that have been described can each be implemented on the computing device 300, in that they are implemented by the computer program code of the computer programs 306 stored on the computer-readable media 304 and executed by the processors 302.

In another embodiment, the components 106, 108, and 110 may be divided over a number of computing devices, however. For instance, one computing device may implement the component 106, whereas another computing device may implement the components 108 and 110. In such cases, the multiple computing devices communicate with one another, such as over a network.

Furthermore, in FIG. 3, the computing device 300 is communicatively connected to the databases 102 and 104 that have been described. As such, in FIG. 3, the databases 102 and 104 are external to the computing device 300. However, in another embodiment, either or both of the databases 102 and 104 may be internal to the computing device 300, as can be appreciated by those of ordinary skill within the art.

As can be appreciated by one those of ordinary skill within the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

In general, a computer program product includes a computer-readable medium on which one or more computer programs are stored. Execution of the computer programs from the computer-readable medium by one or more processors of one or more hardware devices causes a method to be performed. For instance, the method that is to be performed may be one or more of the methods that have been described above.

The computer programs themselves include computer program code. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention have been described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It is finally noted that, although specific embodiments have been illustrated and described herein, it will be appreciated by those of ordinary skill in the art that any arrangement calculated to achieve the same purpose may be substituted for the specific embodiments shown. This application is thus intended to cover any adaptations or variations of embodiments of the present invention. As such and therefore, it is manifestly intended that this invention be limited only by the claims and equivalents thereof.

We claim:

1. A method comprising:
determining one or more attributes of a user;
selecting, by a processor of a computing device, a given advertisement for a product or service from a plurality of advertisements for the product or service, based on the attributes of the user; and,
transmitting the given advertisement selected for the product or service, for viewing by the user.

2. The method of claim 1, wherein the attributes of the user comprise a given theme of multimedia content that appeals most to the user, and wherein determining the attributes of the user comprises selecting the given theme from a plurality of themes.

3. The method of claim 2, wherein each advertisement of the plurality of advertisements for the product or service is particular to a different theme of the plurality of themes.

4. The method of claim 2, wherein the plurality of themes comprises: comedy, action, emotion, drama, and reality-based.

5. The method of claim 1, wherein the attributes of the user are at least substantially static, such that the attributes of the user are determined infrequently.

6. The method of claim 1, wherein the attributes of the user are at least substantially dynamic, such that the attributes of the user are determined frequently.

7. The method of claim 1, wherein the given advertisement is a first given advertisement, the product or service is a first product or service, and the method further comprises:
selecting, by the processor of the computing device, a second given advertisement for a second product or service other than the first product or service, from a plurality of advertisements for the second product or service, based on the attributes of the user; and,
transmitting the second given advertisement for the product or service selected, for viewing by the user.

8. The method of claim 1, wherein determining the attributes of the user comprises:
reviewing a history of multimedia content previously selected and viewed by the user, where each multimedia content has one or more associated attributes; and,
assembling an ordered list of the attributes of the user by counting and ordering the associated attributes of the multimedia content previously selected and viewed by the user.

9. The method of claim 8, wherein selecting the given advertisement for the product or service from the plurality of advertisements for the product or service, based on the attributes of the user, comprises selecting one of the plurality of advertisements that is associated with an attribute of the user at a top of the ordered list.

10. The method of claim 1, wherein selecting the given advertisement for the product or service from the plurality of advertisements for the product or service, based on the attributes of the user, comprises selecting one of the plurality of advertisements for the product or service that best matches the attributes of the user.

11. The method of claim 1, further comprising receiving the plurality of advertisements for the product or service.

12. The method of claim 1, wherein electronically displaying the given advertisement for the product or service selected comprises displaying the given advertisement on a television channel on which the user is currently watching a television program, during a commercial break.

13. The method of claim 1, wherein electronically displaying the given advertisement for the product or service selected comprises displaying the given advertisement on a web page of an Internet web site that the user is currently browsing.

14. A system comprising:
one or more processors;
a first database to store a list of multimedia content previously viewed by a user, each multimedia content having one or more associated themes;
a second database to store a plurality of advertisements for a product or service, each advertisement particular to a different theme; and,
a computer-readable medium to store:
first computer program code to determine a most popular theme of the multimedia content previously viewed by the user, from the associated themes of the multimedia content previously viewed by the user; and,
second computer program code to select a given advertisement of the plurality of advertisements for the product or service to display to the user, as the advertisement having a theme that best matches the most popular theme of the multimedia content previously viewed by the user.

15. The system of claim 14, wherein the computer-readable medium further is to store third computer program code to transmit the given advertisement for the product or service selected for ultimate receipt by a display on which the user views the given advertisement.

16. The system of claim 14, wherein the attributes of the user are at least substantially static, such that the attributes of the user are determined infrequently.

17. The method of claim 1, wherein the attributes of the user are at least substantially dynamic, such that the attributes of the user are determined frequently.

18. A computer program product having one or more computer programs stored thereon, such that execution of the computer programs from the computer program product by one or more processors causes performance of a method, the method comprising:
determining one or more attributes of a user;
selecting a given advertisement for an product or service from a plurality of different advertisements for the product or service, based on the attributes of the user, where the given advertisement selected best matches the attributes of the user as compared to all other of the different advertisements for the product or service.

19. The computer program product of claim 18, wherein the method further comprises transmitting the given advertisement for ultimate viewing by the user.
